(19) United States
(12) Patent Application Publication
(10) Pub. No.: US 2026/0109648 A1
(43) Pub. Date: Apr. 23, 2026

(54) ACTIVE AND PASSIVE INTEGRATED FIREPROOF HEAT-INSULATING BOARD AND PREPARATION METHOD THEREOF

(71) Applicants: CHINA STATE CONSTRUCTION HAILONG TECHNOLOGY COMPANY LIMITED, Shenzhen (CN); HARBIN INSTITUTE OF TECHNOLOGY, Harbin (CN)

(72) Inventors: Baojun ZHAO, Shenzhen (CN); Xiaodong HE, Shenzhen (CN); Xiaoguang WANG, Shenzhen (CN); Liping SHI, Shenzhen (CN); Yesheng ZHONG, Shenzhen (CN); Yangyu FU, Shenzhen (CN); Xiaoliang MA, Shenzhen (CN); Wenqi ZHANG, Shenzhen (CN); Han YANG, Shenzhen (CN); Weilai ZENG, Shenzhen (CN); Meng CUI, Shenzhen (CN)

(73) Assignees: CHINA STATE CONSTRUCTION HAILONG TECHNOLOGY COMPANY LIMITED, Shenzhen (CN); HARBIN INSTITUTE OF TECHNOLOGY, Harbin (CN)

(21) Appl. No.: 19/361,062

(22) Filed: Oct. 17, 2025

(30) Foreign Application Priority Data
Oct. 17, 2024 (CN) 202411454668.3

(51) Int. Cl. C04B 28/34; B32B 5/02; B32B 7/027; B32B 9/04; B32B 13/04; B32B 17/06; C04B 14/06; C04B 14/30; C04B 14/46; C04B 20/00; C04B 22/12; C04B 22/14; C04B 24/04; C04B 38/00; C04B 40/00; C04B 40/02; C04B 103/00; C04B 103/63; C04B 111/00; C04B 111/28

(52) U.S. Cl. CPC C04B 28/344; B32B 5/022; B32B 7/027; B32B 9/04; B32B 17/069; C04B 14/062; C04B 14/305; C04B 14/4656; C04B 20/0036; C04B 22/122; C04B 22/147; C04B 24/04; C04B 38/0045; C04B 40/0039; C04B 40/0082; C04B 40/0218; C04B 40/025; B32B 13/04; B32B 2262/101; B32B 2262/108; B32B 2305/026; B32B 2307/3065; B32B 2607/00; C04B 2103/0071; C04B 2103/63; C04B 2111/00629; C04B 2111/285

(57) ABSTRACT

Provided are an active and passive integrated fireproof heat-insulating board and a preparation method thereof, including: n passive fireproof layers and n or n+1 active fireproof layers, the passive fireproof layers and the active fireproof layers are overlapped with each other into a whole. Each passive fireproof layer includes an inorganic fiber felt and an aerogel; the aerogel is obtained by curing an aerogel stock solution having adhesiveness, and the aerogel stock solution includes, in parts by mass, 1000 to 4000 parts of silica sol, 50 to 150 parts of soluble silicate, 10 to 50 parts of a phosphate adhesive, 5 to 20 parts of quicklime, 5 to 50 parts of titanium dioxide, 10 to 50 parts of calcium stearate, 5 to 50 parts of a hydrophobic modifier, 5 to 50 parts of an acid-base regulator, and 1000 to 4000 parts of a solvent.

### CROSS-REFERENCE TO RELATED APPLICATIONS

This application claims priority to Chinese patent application No. 202411454668.3, filed on Oct. 17, 2024, the entire contents of which are incorporated herein by reference.

### TECHNICAL FIELD

The present disclosure relates to the technical field of building materials, in particular to an active and passive integrated fireproof heat-insulating board and a preparation method thereof.

### BACKGROUND

An integrated fireproof heat-insulating board is a building material that combines both fireproofing and heat insulation functions. It is typically applied to building components such as exterior walls, interior walls, and roofs, aiming to improve the safety and energy efficiency of buildings. In the event of a fire, it can delay the spread of fire, buy time for personnel evacuation, reduce property loss and effectively reduce heat exchange between the interior and the exterior of the building, thereby reducing energy consumption of air conditioners and heating systems, and achieving the purpose of energy conservation and emission reduction. The integrated fireproof heat-insulating board usually includes a multi-layer structure including a fire-resistant layer made of a non-combustible or flame-retardant material, a heat insulation layer made of a thermal insulation phase change material, and other functional layers. Current integrated fireproof heat-insulating boards have the following problems:

(1) The use of organic adhesives to bond different functional layers makes the integrated fireproof heat-insulating board difficult to reach Class A non-combustibility, and the organic components in the integrated fireproof heat-insulating board will release a large amount of toxic and harmful gases in a high-temperature environment or during combustion, making the fire-field environment worse, increasing the difficulty of personnel evacuation, and causing environmental pollution.

(2) The use of organic materials such as polystyrene boards and polystyrene as phase change materials in the integrated fireproof heat-insulating board results in insufficient fireproof performance, posing significant fire potential safety hazards.

(3) The use of porous inorganic fiber materials such as rock wool and perlite as heat-insulating materials in the integrated fireproof heat-insulating board results in relatively high water absorption and poor weather resistance. Water absorption and moisture severely compromise the structural integrity and service life of the integrated fireproof heat-insulating board, reducing their ability to withstand harsh weather and environmental factors. Additionally, water absorption and moisture may also cause a decrease in the fireproof and heat-insulating effects of the integrated fireproof heat-insulating board.

Chinese patent application CN115503300A discloses a composite rock wool fireproof thermal insulation decorative integrated board, including a rock wool thermal insulation layer, a surface treatment layer, and a finishing layer which are sequentially arranged from top to bottom, the surface treatment layer is composed of a surface treatment agent, and the surface treatment agent includes BC-413 pure acrylic emulsion, VAE705 emulsion, and water; the rock wool thermal insulation layer is composed of a rock wool felt and silicon dioxide aerogel slurry; and the finishing layer is composed of silicate cement, fine sand, stone powder, a water reducing agent, sodium polynaphthalene formaldehyde sulfonate, a curing agent, and water. This application increases the bonding strength of the rock wool composite thermal insulation board through the surface treatment layer, improves the tensile property of the rock wool thermal insulation layer and the finishing layer and the acid and alkali resistance of the board; the rock wool felt and the silicon dioxide aerogel are compounded to obtain the rock wool thermal insulation layer, so that the thermal insulation and fireproof performance is improved. The silicon dioxide aerogel is subjected to hydrophobic treatment to reduce the hygroscopicity. This application overcomes the first two disadvantages of the integrated fireproof heat-insulating board, but does not perform any treatment on the rock wool therein and still uses a plurality of organic components, which greatly reduces the fireproof performance and environmental protection of the fireproof heat-insulating board. In addition, the problems of high water absorption and poor weather resistance of rock wool are not effectively solved, which affects the long-term use effect and safety.

Therefore, it is necessary to improve the existing technology to obtain an integrated fireproof heat-insulating board with high fireproof safety performance, good thermal insulation effect, and low hygroscopicity.

### SUMMARY

### (I) Technical Problem to Be Solved

In view of the above-mentioned shortcomings and deficiencies of the prior art, the present disclosure provides an active and passive integrated fireproof heat-insulating board, which solves the problems of high organic content, insufficient fireproof performance and environmental protection, high hygroscopicity, and degradation of performance and safety after long-term use of the integrated fireproof heat-insulating board in the prior art.

### (II) Technical Solution

The present disclosure provides an active and passive integrated fireproof heat-insulating board, including: n passive fireproof layers and n or n+1 active fireproof layers, wherein n is a natural number; the n passive fireproof layers and the n or n+1 active fireproof layers are overlapped with each other into an integrated structure.

The passive fireproof layer includes an aerogel and an inorganic fiber felt serving as a porous skeleton material, the aerogel is filled in pores of the porous skeleton material and coats an exterior of the porous skeleton material; the aerogel is obtained by curing and drying an aerogel stock solution having adhesiveness, and the aerogel stock solution includes, in parts by mass, 1000 to 4000 parts of silica sol, 50 to 150 parts of soluble silicate, 10 to 50 parts of a phosphate adhesive, 5 to 20 parts of quicklime, 5 to 50 parts of titanium dioxide, 10 to 50 parts of calcium stearate, 5 to 50 parts of a hydrophobic modifier, 5 to 50 parts of an acid-base regulator, and 1000 to 4000 parts of a solvent.

In some embodiments, each active fireproof layer is an inorganic fireproof board that actively consumes energy when decomposed by heat.

In some embodiments, the inorganic fireproof board includes at least one of a gypsum fireproof plate, a glass magnesium fireproof plate, a cement fiber plate, and a silicate fiber plate.

In some embodiments, the inorganic fiber felt is a fiber felt composed of one or a mixture of two or more of a mullite fiber felt, an aluminum silicate fiber felt, a glass fiber felt, and an alumina fiber felt.

In some embodiments, in the each passive fireproof layer, a mass ratio of the inorganic fiber felt is in a range of 70% to 95%, with the remainder being the aerogel.

In some embodiments, the phosphate adhesive is at least one of aluminum dihydrogen phosphate, magnesium phosphate, and zinc phosphate; and the soluble silicate is at least one of lithium silicate, sodium silicate, and potassium silicate.

In some embodiments, the aerogel stock solution further includes, in parts by mass, 10 to 30 parts of a phase change microcapsule material, a shell layer of the phase change microcapsule material is one of silicon dioxide, melamine-formaldehyde resin, polyurea-polyurethane, and polyamide, and a phase change core material of the phase change microcapsule material is at least one of paraffin, alkane, fatty acid and esters thereof, sodium sulfate dodecahydrate, calcium chloride hexahydrate, polyethylene glycol, and neopentyl glycol.

The present disclosure further provides a preparation method of the active and passive integrated fireproof heat-insulating board, including:

S1: preparing all raw materials of the aerogel stock solution according to the above active and passive integrated fireproof heat-insulating board, dividing the solvent into a first portion and a second portion, adding the soluble silicate, the quicklime, and the titanium dioxide into the first portion of the solvent, and stirring to obtain a mixed solution 1; adding the silica sol and the phosphate adhesive into the second portion of the solvent, and stirring to obtain a mixed solution 2;

S2: mixing the mixed solution 1 and the mixed solution 2 obtained in the step S1 and stirring to obtain a mixture, and adding the acid-base regulator to adjust the pH of the mixture composed of the mixed solution 1 and the mixed solution 2 to a range of 6 to 7 during the stirring to obtain a mixed solution 3;

S3: adding the calcium stearate and the hydrophobic modifier to the mixed solution 3 obtained in the step S2 and stirring to obtain the aerogel stock solution;

S4: impregnating the inorganic fiber felt with the aerogel stock solution obtained in the step S3 until the inorganic fiber felt is fully impregnated to obtain an inorganic fiber felt impregnated with the aerogel stock solution;

S5: overlapping the inorganic fiber felt impregnated with the aerogel stock solution obtained in the step S4 with the n or n+1 active fireproof layers to obtain an unshaped fireproof heat-insulating board; and S6: subjecting the unshaped fireproof heat-insulating board obtained in the step S5 first to pressurized gel shaping and curing, and then subjecting to microwave drying and aging treatment to obtain the active and passive integrated fireproof heat-insulating board.

In some embodiments, in the step S2, during mixing and stirring the mixed solution 1 and the mixed solution 2, the acid-base regulator is added to adjust the pH of the mixture composed of the mixed solution 1 and the mixed solution 2 to 6. In a weakly acidic condition, the silica sol has better stability, a slower reaction rate, and better adjustability of the pore structure.

In some embodiments, in the step S4, before the inorganic fiber felt is impregnated, the inorganic fiber felt is dried to remove moisture from the inorganic fiber felt to absorb the aerogel stock solution prepared in the step S3.

In some embodiments, in the step S6, conditions for the pressurized gel shaping and curing include: maintaining the unshaped fireproof heat-insulating board obtained in the step S5 at a pressure of 2 MPa to 5 MPa and a temperature of 30° C. to 50° C. for curing for 15 min to 1 h.

In some embodiment of the present disclosure, conditions for the microwave drying and aging treatment include: subjecting the unshaped fireproof heat-insulating board that has finished the pressurized gel shaping and curing to drying and aging in a microwave frequency band of 1000 MHz to 2500 MHz and at a temperature of 50° C. to 100° C. for 1 min to 30 min.

### BRIEF DESCRIPTION OF THE DRAWINGS

FIG. 1 is a schematic diagram of an active and passive integrated fireproof heat-insulating board of Example 1.

FIG. 2 is a schematic diagram of an active and passive integrated fireproof heat-insulating board of Example 4.

FIG. 3 is a schematic diagram of temperature curves of a fire-exposed surface and temperature curves of an unexposed surface of an active and passive integrated fireproof heat-insulating board according to some embodiments in the present disclosure.

FIG. 4 is a schematic diagram of temperature curves of an unexposed surface of an active and passive integrated fireproof heat-insulating board according to some embodiments in the present disclosure.

FIG. 5 is a schematic diagram of a state of the active and passive integrated fireproof heat-insulating board of Example 1 during a combustion test.

FIG. 6 is a schematic diagram of a back view of the active and passive integrated fireproof heat-insulating board of Example 1 after the combustion test.

### DETAILED DESCRIPTION

In order to better explain the present disclosure and facilitate understanding, the present disclosure will be described in detail below with reference to the accompanying drawings and specific embodiments.

It should be noted that the aerogel stock solutions mentioned below are all aerogel stock solutions with adhesiveness, which can also be called adhesive aerogel stock solutions.

An active and passive integrated fireproof heat-insulating board provided by the present disclosure includes n passive fireproof layers and n or n+1 active fireproof layers, wherein n is a natural number. The passive fireproof layers refer to fireproof layers made of refractory materials.

The passive fireproof layers and the active fireproof layers are overlapped with each other into an integrated structure. In some embodiments, the passive fireproof layers and the active fireproof layers are overlapped in a manner including an alternate overlapping manner or a sandwich filling overlapping manner. The alternate overlapping manner may be layer-layer alternate overlapping with a passive fireproof layer and an active fireproof layer, or group-group alternate overlapping with two or more passive fireproof layers as one group and two or more active fireproof layers as another group.

The sandwich filling overlapping manner refers to an overlapping manner in which one passive fireproof layer is sandwiched between two active fireproof layers.

In some embodiments, the passive fireproof layer includes an aerogel and an inorganic fiber felt serving as a porous skeleton material. The aerogel is filled in pores of the porous skeleton material and coats an exterior of the porous skeleton material. The aerogel coating the exterior of the porous skeleton material can be understood as the aerogel coats an outer surface of the entire porous skeleton material, and the pores inside the porous skeleton material have been filled with the aerogel.

The aerogel is obtained by curing and drying an aerogel stock solution having adhesiveness. The aerogel stock solution includes, in parts by mass, 1000 to 4000 parts of silica sol, 50 to 150 parts of soluble silicate, 10 to 50 parts of a phosphate adhesive, 5 to 20 parts of quicklime, 5 to 50 parts of titanium dioxide, 10 to 50 parts of calcium stearate, 5 to 50 parts of a hydrophobic modifier, 5 to 50 parts of an acid-base regulator (also referred to as a pH regulator), and 1000 to 4000 parts of solvent.

In some embodiments, the active fireproofing layer is an inorganic fireproofing board that actively consumes energy when decomposed by heat. The active fireproofing layer can be decomposed under fire, absorbing heat and releasing water vapor during decomposition.

In some embodiments, the inorganic fireproofing board includes at least one of a gypsum fireproof plate, a glass magnesium fireproof plate, a cement fiber plate, a silicate fiber plate.

The active fireproofing layer may be a common fireproof board available on the market, which absorbs heat and releases water vapor when decomposed, and the thickness of the active fireproof layer is in a range of 10 to 150 mm. In some embodiments, the thickness of the active fireproof layer is in a range of 10 to 80 mm. In some embodiments, the thickness of the active fireproof layer is in a range of 80 to 150 mm. In some embodiments, the thickness of the active fireproof layer is one of 10 mm, 20 mm, 30 mm, 40 mm, 50 mm, 70 mm, 80 mm, 100 mm, and 150 mm.

The aerogel is a nanoporous solid material. The aerogel stock solution refers to a precursor solution or wet gel that has not yet undergone the drying step during the aerogel preparation process.

The porous skeleton material refers to a crystalline or amorphous material with a network structure composed of a plurality of interconnected or closed pores.

The inorganic fiber felt is a porous skeleton material made of inorganic fibers that is soft, porous, and lightweight.

The adhesiveness refers to the adhesion of the aerogel stock solution to the inorganic fiber felt and the active fireproof layer.

In some embodiments, the inorganic fiber felt is a fiber felt composed of one or a mixture of two or more of a mullite fiber felt, an aluminum silicate fiber felt, a glass fiber felt, and an alumina fiber felt. The inorganic fiber felt may be a common inorganic fiber felt on the market.

In some embodiments, a thickness of the inorganic fiber felt is in a range of 5 to 30 mm. In some embodiments, the thickness of the inorganic fiber felt is in a range of 5 to 15 mm. In some embodiments, the thickness of the inorganic fiber felt is in a range of 5 to 20 mm. In some embodiments, the thickness of the inorganic fiber felt is in a range of 15 to 30 mm. In some embodiments, the thickness of the inorganic fiber felt is in a range of 20 to 30 mm. In some embodiments, the thickness of the inorganic fiber felt may be 5 mm, 10 mm, 15 mm, 20 mm, 25 mm, or 30 mm.

In some embodiments, in the passive fireproof layer, a mass ratio of the inorganic fiber felt is in a range of 70% to 95%, with the remainder being the aerogel.

In some embodiments, in the passive fireproof layer, the mass ratio of the inorganic fiber felt is in a range of 85% to 90%.

In some embodiments, in the passive fireproof layer, the mass ratio of the inorganic fiber felt is in a range of 85% to 90%, and a mass ratio of the aerogel is in a range of 10% to 15%.

In some embodiments, in the passive fireproof layer, the mass ratio of the inorganic fiber felt is in a range of 70% to 85%, and the mass ratio of the aerogel is in a range of 15% to 30%.

In some embodiments, in the passive fireproof layer, the mass ratio of the inorganic fiber felt is in a range of 85% to 95%, and the mass ratio of the aerogel is in a range of 5% to 15%.

In some embodiments, in the passive fireproof layer, the mass ratio of the inorganic fiber felt is one of 70%, 80%, 85%, 90%, and 95%. In some embodiments, in the passive fireproof layer, the mass ratio of the aerogel is one of 5%, 10%, 15%, 20%, and 30%. By this way, the structural strength of the passive fireproof layer can be greatly improved, and it is convenient to be assembled in a building wall using metal parts such as screws.

In some embodiments, the silica sol is a commercially available product having a solid content of more than 25%. The commercially available silica sol product is a dispersion containing nanoscale silica particles that are uniformly distributed in water or organic solvents.

In some embodiments, the phosphate adhesive is at least one of aluminum dihydrogen phosphate, magnesium phosphate, and zinc phosphate. These phosphate adhesives function both as an adhesive and as a flame retardant.

In some embodiments, the phosphate adhesive is aluminum dihydrogen phosphate. The aluminum dihydrogen phosphate has strong high temperature resistance and flame retardancy.

The phosphate adhesive may also be used as a catalyst to promote the hydrolysis of silica sol in the aerogel raw material and enhance the strength of the aerogel. The phosphate adhesive can promote the adhesion of the aerogel stock solution, so that the aerogel stock solution can be well adhered to the inorganic fiber felt, and the inorganic fiber felt impregnated with the aerogel stock solution can be firmly bonded to the active fireproof layer to form an integrated heat-insulating board.

In some embodiments, the soluble silicate is at least one of lithium silicate, sodium silicate, and potassium silicate. These silicates are both pH regulators and inorganic binders, and may also act as catalysts to accelerate the condensation reaction of sol precursors (such as the silica sol) to form a more uniform and stable sol system, thereby obtaining a higher quality aerogel. These soluble silicates can alter the structure of the silicon-oxygen skeleton to a certain extent. In addition, the soluble silicates mainly enhance the network structure by introducing additional silicon oxygen bonds, thereby improving the mechanical strength and thermal stability of the aerogel. In addition, the soluble silicate can control the density and porosity of the aerogel, and the aerogel with different pore size distributions and specific surface areas may be prepared by changing the ratio of the soluble silicate in the aerogel stock solution.

In some embodiments, metal oxides such as quicklime and titanium dioxide are added to the aerogel stock solution to form an inorganic adhesive together with the aluminum dihydrogen phosphate, which can promote the hydrolysis of the silica sol in the preparation process of the passive fireproof layer and enhance the strength of the aerogel, improve the durability of the connection between the passive fireproof layer and the active fireproof layer, and prevent the peeling at the connection between the passive fireproof layer and the active fireproof layer after prolonged use.

In some embodiments, the calcium stearate added to the aerogel stock solution may be used to modify the surface of the aerogel particles to impart the aerogel particles hydrophobicity to help prevent agglomeration of the nanoscale particles, thereby improving the stability of the aerogel stock solution to obtain a uniform aerogel structure, so as to avoid forming large pores or an uneven density distribution, and enhance the mechanical strength, toughness, and high-temperature stability of the aerogel. The calcium stearate may also be used as a lubricant to improve the mixing uniformity and flowability, making the processing procedure smoother.

In some embodiments, the hydrophobic modifier may be at least one of polydimethylsiloxane, trimethylchlorosilane, hexamethyldisilazane, hexamethyldisiloxane, methyltrimethoxysilane, methyltriethoxysilane, dimethyldimethoxysilane, and dimethyldiethoxysilane.

In some embodiments, the hydrophobic modifier is added to the aerogel stock solution to change the water absorption of the aerogel, which prevents the pores within the aerogel from absorbing water, which causes the self-weight of the heat-insulating board to increase and potentially lead to safety hazards.

In some embodiments, the acid-base regulator may be at least one of acetic acid, hydrochloric acid, phosphoric acid, sulfuric acid, ammonia water, ammonium carbonate, and ammonium bicarbonate. The acid-base regulator is used to provide a weakly acidic environment to properly stabilize the aerogel stock solution, so as to avoid problems such as low aerogel strength and an uneven pore size/structure distribution caused by an excessively fast formation speed of the aerogel.

In some embodiments, the solvent is water, methanol, or ethanol. In some embodiments, the solvent is water.

In some embodiments, when the solvent in the aerogel stock solution is water, the amount of water is preferably 2000 to 4000 parts by mass. In some embodiments, when the solvent in the aerogel stock solution is water, the amount of water is 2000 to 3000 parts or 3000 to 4000 parts by mass. In some embodiments, when the solvent in the aerogel stock solution is water, the amount of water is 2000 parts, 2500 parts, 3000 parts, 3500 parts, 3600 parts, or 4000 parts by mass.

In some embodiments, in parts by mass, the amount of the silica sol in the aerogel stock solution is 1000 to 2000 parts, 2000 to 3000 parts, 3000 to 3500 parts, or 3500 to 4000 parts. In some embodiments, in parts by mass, the amount of the silica sol in the aerogel stock solution is 1000 parts, 2000 parts, 3000 parts, 3500 parts, or 4000 parts.

In some embodiments, in parts by mass, the amount of the soluble silicate in the aerogel stock solution is 50 to 70 parts, 70 to 90 parts, 90 to 110 parts, 110 to 130 parts, or 130 to 150 parts. In some embodiments, in parts by mass, the amount of the soluble silicate in the aerogel stock solution is 50 parts, 60 parts, 70 parts, 80 parts, 90 parts, 100 parts, 110 parts, 120 parts, 130 parts, 140 parts, or 150 parts.

In some embodiments, in parts by mass, the amount of the phosphate adhesive in the aerogel stock solution is 10 to 20 parts, 20 to 30 parts, 30 to 40 parts, or 40 to 50 parts. In some embodiments, in parts by mass, the amount of the phosphate adhesive in the aerogel stock solution is 10 parts, 15 parts, 20 parts, 30 parts, 40 parts, or 50 parts.

In some embodiments, in parts by mass, the amount of the quicklime in the aerogel stock solution is 5 to 8 parts, 8 to 12 parts, 12 to 15 parts, 15 to 17 parts, or 17 to 20 parts. In some embodiments, in parts by mass, the amount of the quicklime in the aerogel stock solution is 5 parts, 8 parts, 10 parts, 12 parts, 15 parts, 17 parts, or 20 parts.

In some embodiments, in parts by mass, the amount of the titanium dioxide in the aerogel stock solution is 5 to 15 parts, 15 to 30 parts, 30 to 40 parts, or 40 to 50 parts. In some embodiments, in parts by mass, the amount of the titanium dioxide in the aerogel stock solution is 5 parts, 10 parts, 15 parts, 20 parts, 30 parts, 40 parts, or 50 parts.

In some embodiments, in parts by mass, the amount of the calcium stearate in the aerogel stock solution is 10 to 20 parts, 20 to 30 parts, 30 to 40 parts, or 40 to 50 parts. In some embodiments, in parts by mass, the amount of the calcium stearate in the aerogel stock solution is 10 parts, 20 parts, 30 parts, 40 parts, or 50 parts.

In some embodiments, in parts by mass, the amount of the hydrophobic modifier in the aerogel stock solution is 5 to 15 parts, 15 to 30 parts, 30 to 40 parts, or 40 to 50 parts. In some embodiments, in parts by mass, the amount of the hydrophobic modifier in the aerogel stock solution is 5 parts, 15 parts, 20 parts, 30 parts, 40 parts, or 50 parts.

In some embodiments, in parts by mass, the amount of the acid-base regulator in the aerogel stock solution is 5 to 25 parts, 10 to 20 parts, 20 to 30 parts, 30 to 40 parts, or 40 to 50 parts. In some embodiments, in parts by mass, the amount of the acid-base regulator in the aerogel stock solution is 5 parts, 10 parts, 20 parts, 30 parts, 40 parts, or 50 parts.

The structure of the active and passive integrated fireproof heat-insulating board of the present disclosure has the following beneficial effects:

1. Since no organic adhesive is used between the active fireproof layer and the passive fireproof layer, compared with the prior art, the integrated fireproof heat-insulating board of the present disclosure has a lower organic content and higher fireproof capability, and the fireproof limit time of the integrated fireproof heat-insulating board can reach 1.5 h or more, and can reach the Class A non-combustibility or above.

2. Since the passive fireproof layer of the present disclosure adopts a composite structure of the aerogel and the inorganic fiber felt, and the phosphate adhesive (preferably aluminum dihydrogen phosphate) and the titanium dioxide are added into the aerogel, the phosphate adhesive is an inorganic adhesive, which not only has good fireproof performance, but also has good adhesion. The quicklime promotes the hydrolysis of silica sol in the passive fireproof layer and enhances the strength of the aerogel, and at the same time, enhances the bonding strength between the aerogel and the fiber, and between the passive fireproof layer and the active fireproof layer.

By adding the phosphate adhesive, the aerogel stock solution has good adhesion, so that the aerogel can be firmly bonded with the inorganic fiber felt to improve the strength of the heat-insulating board, and the inorganic fiber felt impregnated with the aerogel stock solution and the active fireproof layer can be well combined into an integrated structure under pressure treatment (2 to 5 MPa), thereby avoiding delamination and improving durability.

3. The present disclosure also increases the hydrophobicity of the integrated fireproof heat-insulating board by adding the hydrophobic modifier to the passive fireproof layer. Compared with the prior art, the 24 h water absorption rate of the fireproof heat-insulating board of the present disclosure is reduced from 70% to 4%. Since the hydrophobic modifier is added to the aerogel stock solution, the inorganic fiber felt is also subjected to hydrophobic modification when impregnated and coated. Compared with the prior art, the hygroscopicity of the inorganic fiber felt can be greatly reduced, the weather resistance of the heat-insulating board is improved, the heat-insulating board is prevented from being peeled off from the building due to excessive weight after being hygroscopic, thereby improving the usage safety.

4. The passive fireproof layer and the active fireproof layer of the present disclosure are overlapped, and through synergistic effects, derived from the active fireproofing principle and the passive fireproof principle, the fire resistance limit of the active and passive integrated fireproof heat-insulating board can be significantly improved. The active fireproofing principle includes that the active fireproof layer decomposes under fire, absorbing heat and releasing water vapor during decomposition. The passive fireproof principle includes that the passive fireproof layer has a low thermal conductivity and heat insulation. The three-layer composite fireproof heat-insulating board, fabricated by sandwiching an inorganic fiber felt-reinforced aerogel layer between two active fireproof layers (i.e., a sandwich-structured, active and passive integrated fireproof heat-insulating board with the inorganic fiber felt-reinforced aerogel layer sandwiched in the middle), exhibits a fire resistance rating more than 30% higher than that of a single-layer active fireproof board of the same total thickness. During the fire resistance test, the temperature plateau on the temperature-rise curve of the unexposed surface is reduced by 0° C. to 30° C., and the equivalent thermal conductivity may reach below 0.09 W/(m·K).

5. Since the present disclosure introduces a large amount of aerogel and inorganic fibers into the active and passive integrated fireproof heat-insulating board, the equivalent density of the active and passive integrated fireproof heat-insulating board is remarkably reduced while the structural strength is met. The active and passive integrated fireproof heat-insulating board has the characteristics of light weight and high strength, and is suitable for use in steel structure buildings and fabricated buildings. The active and passive integrated fireproof heat-insulating board may be treated with a decorative layer on the surface of the active fireproof layer according to needs, thereby improving fireproof and thermal insulation performance and decorative performance.

6. The aerogel is used as a porous high-efficiency thermal insulation material, and the extremely high porosity of the aerogel leads to characteristics such as low density, low thermal conductivity, and high specific surface area of the aerogel. The aerogel stock solution having adhesiveness prepared by the present disclosure can further improve the fire resistance, temperature adjustment capability, corrosion resistance, hydrophobic capability, bonding capability, structural strength, and other properties of the aerogel.

In some embodiments, 10 to 30 parts by mass of the phase change microcapsule material is further added to the aerogel stock solution. The phase change microcapsule material may be added to the aerogel stock solution together with calcium stearate, and stirred evenly at a low speed to avoid the shear force of high-speed stirring from destroying the phase change microcapsule material.

The phase change microcapsule material is a composite material that encapsulates phase change material in micron or nanometer-scale capsules. For the preparation method of the phase change microcapsule material, please refer to the relevant description in Example 4 below.

In some embodiments, 10 to 15 parts by mass of the phase change microcapsule material is added to the aerogel stock solution. In some embodiments, 10 to 20 parts by mass of the phase change microcapsule material is added to the aerogel stock solution. In some embodiments, 15 to 30 parts by mass of the phase change microcapsule material is added to the aerogel stock solution. In some embodiments, 10 parts, 15 parts, 20 parts, 25 parts, or 30 parts by mass of the phase change microcapsule material is added to the aerogel stock solution.

In some embodiments, a shell layer of the phase change microcapsule material is one of silicon dioxide, melamine-formaldehyde resin, polyurea-polyurethane, and polyamide. A phase change core material of the phase change microcapsule material is at least one of paraffin, alkane, fatty acid and esters thereof, sodium sulfate dodecahydrate, calcium chloride hexahydrate, polyethylene glycol, and neopentyl glycol.

In some embodiments, the shell layer of the phase change microcapsule material is polyurea-polyurethane or polyamide, and flame retardant element monomers or additives are introduced into the polyurea-polyurethane or polyamide.

Both the silica shell layer and the melamine-formaldehyde resin are inherently flame-retardant. The polyurea-polyurethane or the polyamide can further improve the flame retardant performance by introducing monomers or additives containing flame retardant elements such as phosphorus, halogen, nitrogen and the like.

In some embodiments, the shell layer of the phase change microcapsule material is silicon dioxide, making the phase change microcapsule material have good compatibility with the silicon aerogel. The phase change microcapsule material has good flame-retardant properties due to the silicon dioxide being an inorganic material. When the silicon dioxide is used as the shell layer of the phase change microcapsule, the phase change core material can be wrapped by a sol-gel method, which can be prepared according to the existing technology.

In some embodiments, the shell layer of the phase change microcapsule material may also be melamine-formaldehyde resin. Although the melamine-formaldehyde resin is an organic polymer, it can expand and form a carbon layer when heated to provide additional protection, and therefore also has a certain flame retardancy.

In some embodiments of the present disclosure, a small amount of phase change microcapsule material is added to the aerogel stock solution to enhance the active temperature regulation function of the heat-insulating board, achieve heat insulation/cold insulation, reduce indoor heat/cold loss, reduce building energy loss, and achieve energy saving.

The present disclosure further provides a preparation method of an active and passive integrated fireproof heat-insulating board, including the following steps S1 to S6.

S1: preparing all raw materials according to the compositions of the aerogel stock solution having adhesiveness in the above descriptions, dividing the solvent into a first portion and a second portion, adding the soluble silicate, the quicklime, and the titanium dioxide into the first portion of the solvent, and stirring to obtain a mixed solution 1; adding silica sol and a phosphate adhesive into the second portion of the solvent, and stirring to obtain a mixed solution 2.

For descriptions on the solvent, the soluble silicate, the quicklime, the titanium dioxide, the silica sol, and the phosphate adhesive, please refer to the relevant descriptions of the active and passive integrated fireproof heat-insulating board.

In some embodiments, in step S1, the stirring speed is a low-speed stirring of 100 r/min to 800 r/min, and the amount of the first portion or the second portion used each time is ½ of the total amount of the solvent.

In some embodiments, when the solvent in the aerogel stock solution is water, the amount of water is 2000 to 4000 parts by mass. In some embodiments, when the solvent in the aerogel stock solution is water, the amount of water is 2000 to 3000 parts or 3000 to 4000 parts by mass. In some embodiments, when the solvent in the aerogel stock solution is water, the amount of water is 2000 parts, 2500 parts, 3000 parts, 3500 parts, or 4000 parts by mass.

In some embodiments, in the step S1, in parts by mass, 50 to 150 parts of the soluble silicate, 5 to 20 parts of the quicklime, and 5 to 50 parts of the titanium dioxide are added to the first portion of the solvent; and 1000 to 4000 parts of the silica sol and 10 to 50 parts of the phosphate adhesive are added to the second portion of the solvent.

In some embodiments, in parts by mass, the soluble silicate added to the first portion is in a range of 50 to 70 parts, 70 to 90 parts, 90 to 110 parts, 110 to 130 parts, or 130 to 150 parts. In some embodiments, in parts by mass, the soluble silicate added to the first portion is 50 parts, 60 parts, 70 parts, 80 parts, 90 parts, 100 parts, 110 parts, 120 parts, 130 parts, 140 parts, or 150 parts.

In some embodiments, in parts by mass, the quicklime added to the first portion is in a range of 5 to 8 parts, 8 to 12 parts, 12 to 15 parts, 15 to 17 parts, or 17 to 20 parts. In some embodiments, in parts by mass, the quicklime added to the first portion is 5 parts, 8 parts, 12parts, 15 parts, 17 parts, or 20 parts.

In some embodiments, in parts by mass, the titanium dioxide added to the first portion is in a range of 5 to 15 parts, 15 to 30 parts, 30 to 40 parts, or 40 to 50 parts. In some embodiments, in parts by mass, the titanium dioxide added to the first portion is 5 parts, 15 parts, 20 parts, 30 parts, 40 parts, or 50 parts.

In some embodiments, in parts by mass, the silica sol added to the second portion is in a range of 1000 to 2000 parts, 2000 to 3000 parts, 3000 to 3500 parts, or 3500 to 4000 parts. In some embodiments, in parts by mass, the silica sol added to the second portion is one of 1000 parts, 2000 parts, 3000 parts, 3500 parts, or 4000 parts.

In some embodiments, in parts by mass, the phosphate adhesive added to the second portion is in a range of 10 to 20 parts, 20 to 30 parts, 30 to 40 parts, or 40 to 50 parts. In some embodiments, in parts by mass, the phosphate adhesive added to the second portion is 10 parts, 20 parts, 30 parts, 40 parts, or 50 parts.

S2: mixing the mixed solution 1 and the mixed solution 2 obtained in the step S1 and stirring to obtain a mixture, and adding the acid-base regulator to adjust the pH of the mixture composed of the mixed solution 1 and the mixed solution 2 to a range of 6 to 7 during the stirring to obtain a mixed solution 3;

In some embodiments, in the step S2, the stirring speed is a high stirring speed of 1500 r/min-2000 r/min. In some embodiments, in the step S2, the stirring speed is a high stirring speed of 1500 r/min-1800 r/min. In some embodiments, in the step S2, the stirring speed is a high stirring speed of 1800 r/min-2000 r/min. In some embodiments, in the step S2, the stirring speed is 1500 r/min, 1800 r/min, or 2000 r/min.

In some embodiments, in the step S2, during the stirring, the acid-base regulator is added in an amount of 5 to 50 parts by mass.

In some embodiments, during the stirring, the acid-base regulator is added in an amount of 5-25 parts, 10-20 parts, 20-30 parts, 30-40 parts, or 40-50 parts by mass. In some embodiments, during the stirring, the acid-base regulator is added in an amount of 10 parts, 20 parts, 30 parts, 40 parts, or 50 parts by mass.

S3: adding the calcium stearate and the hydrophobic modifier to the mixed solution 3 obtained in the step S2 and stirring to obtain the aerogel stock solution.

For descriptions on the calcium stearate, the hydrophobic modifier, and the aerogel stock solution, please refer to the relevant descriptions of the active and passive integrated fireproof heat-insulating board.

In some embodiments, in the step S3, in parts by mass, 10 to 50 parts of the calcium stearate and 5 to 50 parts of the hydrophobic modifier are added to the mixed solution 3.

In some embodiments, in parts by mass, the calcium stearate added to the mixed solution 3 is in a range of 10 to 20 parts, 20 to 30 parts, 30 to 40 parts, or 40 to 50 parts. In some embodiments, in parts by mass, the calcium stearate added to the mixed solution 3 is 10 parts, 20parts, 30 parts, 40 parts, or 50 parts.

In some embodiments, in the step S3, the stirring speed is a low stirring speed of 100 r/min-800 r/min. In some embodiments, in the step S3, the stirring speed is a low stirring speed of 100 r/min-400 r/min. In some embodiments, in the step S3, the stirring speed is a low stirring speed of 400 r/min-800 r/min. In some embodiments, in the step S3, the stirring speed is 100 r/min, 400 r/min, or 800 r/min.

In some embodiments, in the step S3, the calcium stearate, the hydrophobic modifier, and the phase change microcapsule material are added to the mixed solution 3 obtained in step S2 and stirred to obtain the aerogel stock solution.

In some embodiments, in the step S3, the phase change microcapsule material may be added together with the calcium stearate and stirred evenly at a low speed to prevent the shear force of high-speed stirring from damaging the phase change microcapsule material.

In some embodiments, in the step S3, in parts by mass, the phase change microcapsule material added together with calcium stearate to the mixed solution 3 is in a range of 10 to 30 parts. In some embodiments, in parts by mass, the phase change microcapsule material added to the mixed solution 3 obtained in the step S2 is in a range of 10 to 15 parts. In some embodiments, in parts by mass, the phase change microcapsule material added to the mixed solution 3 obtained in the step S2 is in a range of 10 to 20 parts. In some embodiments, in parts by mass, the phase change microcapsule material added to the mixed solution 3 obtained in the step S2 is in a range of 15 to 30 parts. In some embodiments, in parts by mass, the phase change microcapsule material added to the mixed solution 3 obtained in the step S2 is 10 parts, 15 parts, 20 parts, 25 parts, or 30 parts.

S4: impregnating the inorganic fiber felt with the aerogel stock solution obtained in the step S3 until the inorganic fiber felt is fully saturated to obtain an inorganic fiber felt impregnated with the aerogel stock solution.

For descriptions on the inorganic fiber felt, please refer to the relevant descriptions of the active and passive integrated fireproof heat-insulating board.

S5: overlapping the inorganic fiber felt impregnated with the aerogel stock solution obtained in the step S4 with the n or n+1 active fireproof layers to obtain an unshaped fireproof heat-insulating board.

The unshaped fireproof heat-insulating board refers to a fireproof heat-insulating board in an uncured state. The aerogel stock solution in the unshaped fireproof heat-insulating board is still in an undried and uncured state. For descriptions on above active fireproof layer, please refer to the relevant descriptions of the active and passive integrated fireproof heat-insulating board.

In some embodiments, in the step S5, the inorganic fiber felt impregnated with the aerogel stock solution is overlapped with the active fireproof layer in an alternate overlapping manner or a sandwich filling overlapping manner. The alternate overlapping manner may be layer-layer alternate overlapping with an inorganic fiber felt and an active fireproof layer, or group-group alternate overlapping with two or more inorganic fiber felts as one group and two or more active fireproof layers as another group.

S6: subjecting the unshaped fireproof heat-insulating board obtained in the step S5 first to pressurized gel shaping and curing, and then subjecting to microwave drying and aging treatment to obtain the active and passive integrated fireproof heat-insulating board.

The pressurized gel shaping and curing refers to maintaining the unshaped fireproof heat-insulating board obtained in the step S5 at a pressure of 2 MPa to 5 MPa and a temperature of 30° C. to 50° C. for 15 min to 1 h.

In some embodiments, the unshaped fireproof heat-insulating board obtained in the step S5 is maintained at a pressure of 2 MPa to 3 MPa and a temperature of 30° C. to 40° C. for 15 min to 30 min. In some embodiments, the unshaped fireproof heat-insulating board obtained in the step S5 is maintained at a pressure of 3 MPa to 5 MPa and a temperature of 35° C. to 40° C. for 15 min to 1 h. In some embodiments, the unshaped fireproof heat-insulating board obtained in the step S5 is maintained at a pressure of 2 MPa, 3 MPa, 4 MPa, or 5 MPa and a temperature of 30° C., 35° C., 40° C., 45° C., or 50° C. for a time of 15 min, 20 min, 30 min, 40 min, 50 min, or 1 h.

In some embodiments, after the pressurized gel shaping and curing, the unshaped fireproof heat-insulating board undergoes the microwave drying and aging treatment in a microwave frequency band of 1000 to 2500 MHz and at a temperature of 50° C. to 100° C. for 1 to 30 min. The microwave drying and aging treatment not only strengthens the bond between the passive fireproof layer and the active fireproof layer but also further decomposes or evaporates organic materials introduced during the preparation process of the fireproof heat-insulating board, reducing the organic content of the board and improving the flame retardancy thereof.

In some embodiments, after the pressurized gel shaping and curing, the unshaped fireproof heat-insulating board undergoes the microwave drying and aging treatment in a microwave frequency band of 1000 to 1800 MHz and at a temperature of 50° C. to 75° C. for 1 to 15 min. In some embodiments, after the pressurized gel shaping and curing, the unshaped fireproof heat-insulating board undergoes the microwave drying and aging treatment in a microwave frequency band of 1800 to 2500 MHz and at a temperature of 75° C. to 100° C. for 1 to 20 min. In some embodiments, after the pressurized gel shaping and curing, the unshaped fireproof heat-insulating board undergoes the microwave drying and aging treatment at a microwave frequency of 1000 MHz, 1500 MHz, 2000 MHz, or 2500 MHz, and a temperature of 50° C., 60° C., 75° C., or 10° C. for 1 min, 10 min, 15 min, 20 min, 25 min, or 30 min.

In some embodiments, in the step S2, in the process of mixing and stirring the mixed solution 1 and the mixed solution 2, the acid-base regulator is added to adjust the pH, so that the pH of the aerogel stock solution obtained after stirring is 6, the weakly acidic environment is maintained in the stirring process. At this time, the stability of the silica sol is good, the reaction rate is slow, and the adjustability of the pore structure is better. But the acidic environment should not be too strong, so as to avoid causing the aerogel to form too slowly, affecting the formation period of the heat-insulating board to be prolonged, and reducing the strength of the aerogel.

In some embodiments, in the step S4, before the inorganic fiber felt is impregnated, the inorganic fiber felt is dried to remove moisture from the inorganic fiber felt so that the inorganic fiber felt may fully absorb the aerogel stock solution obtained in the step S3.

In some embodiments, in the step S4, before the inorganic fiber felt is impregnated, the inorganic fiber felt is dried at a temperature of 40° C. to 120° C., and a drying time of 12 h to 24 h.

In some embodiments, the inorganic fiber felt is dried at a temperature of 40° C. to 60° C. and a drying time of 12 h to 18 h. In some embodiments, the inorganic fiber felt is dried at a temperature of 40° C. to 80° C. and a drying time of 12 h to 20 h. In some embodiments, the inorganic fiber felt is dried at a temperature of 60° C. to 120° C. and a drying time of 16 h to 24 h. In some embodiments, the inorganic fiber felt is dried at a temperature of 40° C., 50° C., 60° C., 70° C., 80° C., 90° C., 100° C., 110° C., or 120° C. and a drying time of 12 h, 13 h, 14 h, 15 h, 16 h, 17 h, 18 h, 19 h, 20 h, 21 h, 22 h, 23 h, or 24 h.

In some embodiments, in the step S4, when the inorganic fiber felt is impregnated, the impregnation time is in a range of 2 min to 30 min. The inorganic fiber felt has a thickness in a range of 5 mm to 30 mm.

In some embodiments, in the step S4, when the inorganic fiber felt is impregnated, the impregnation time is in a range of 2 min to 10 min. In some embodiments, in the step S4, when the inorganic fiber felt is impregnated, the impregnation time is in a range of 2 min to 15 min. In some embodiments, in the step S4, when the inorganic fiber felt is impregnated, the impregnation time is in a range of 2 min to 20 min. In some embodiments, in the step S4, when the inorganic fiber felt is impregnated, the impregnation time is in a range of 2 min to 25 min. In some embodiments, in the step S4, when the inorganic fiber felt is impregnated, the impregnation time is in a range of 10 min to 20 min. In some embodiments, in the step S4, when the inorganic fiber felt is impregnated, the impregnation time is in a range of 15 min to 30 min. In some embodiments, in the step S4, when the inorganic fiber felt is impregnated, the impregnation time is 2 min, 5 min, 10 min, 15 min, 20 min, 25 min, or 30 min.

In some embodiments, the inorganic fiber felt has a thickness in a range of 5 mm to 10 mm. In some embodiments, the inorganic fiber felt has a thickness in a range of 5 mm to 15 mm. In some embodiments, the inorganic fiber felt has a thickness in a range of 5 mm to 20 mm. In some embodiments, the inorganic fiber felt has a thickness in a range of 5 mm to 25 mm. In some embodiments, the inorganic fiber felt has a thickness in a range of 15 mm to 20 mm. In some embodiments, the inorganic fiber felt has a thickness in a range of 15 mm to 30 mm. In some embodiments, the inorganic fiber felt has a thickness of 5 mm, 10 mm, 15 mm, 20 mm, 25 mm, or 30 mm.

In some embodiments, in the step S6, a layer of plastic film (protective film) is coated on the unshaped fireproof heat-insulating board, and then the pressurized gel shaping and curing is performed maintaining at a pressure of 2 MPa to 5 MPa and a temperature of 30° C. to 50° C. for 15 min to 1 h. The plastic film can prevent rapid volatilization of moisture.

In some embodiments, in the step S6, the layer of plastic film (protective film) is coated on the unshaped fireproof heat-insulating board, and then the pressurized gel shaping and curing is performed maintaining at a pressure of 2 MPa to 3 MPa and a temperature of 30° C. to 40° C. for 15 min to 30 min. In some embodiments, in the step S6, the layer of plastic film (protective film) is coated on the unshaped fireproof heat-insulating board, and then the pressurized gel shaping and curing is performed maintaining at a pressure of 3 MPa to 5 MPa and a temperature of 40° C. to 50° C. for 15 min to 30 min. In some embodiments, in the step S6, the layer of plastic film (protective film) is coated on the unshaped fireproof heat-insulating board, and then the pressurized gel shaping and curing is performed maintaining at a pressure of 2 MPa, 3 MPa, 4MPa, or 5 MPa and a temperature of 30° C., 35° C., 40° C., 45° C., or 50° C. for 15 min, 20 min, 30 min, 40 min, 50 min, or 1 h.

In some embodiments, after the pressurized gel shaping and curing, the unshaped fireproof heat-insulating board undergoes the microwave drying and aging treatment in a microwave frequency band of 1000 MHz to 2500 MHz and at a temperature of 50° C. to 100° C. for 1 min to 30 min.

In order to better understand the above technical solutions, exemplary examples of the present disclosure will be described in more detail below with reference to the accompanying drawings. Although exemplary examples of the present disclosure are shown in the accompanying drawings, it should be understood that the present disclosure can be implemented in various forms and should not be limited by the examples set forth herein. Rather, these examples are provided so that the present disclosure can be understood more clearly and thoroughly, and the scope of the present disclosure can be completely conveyed to those skilled in the art.

Example 1

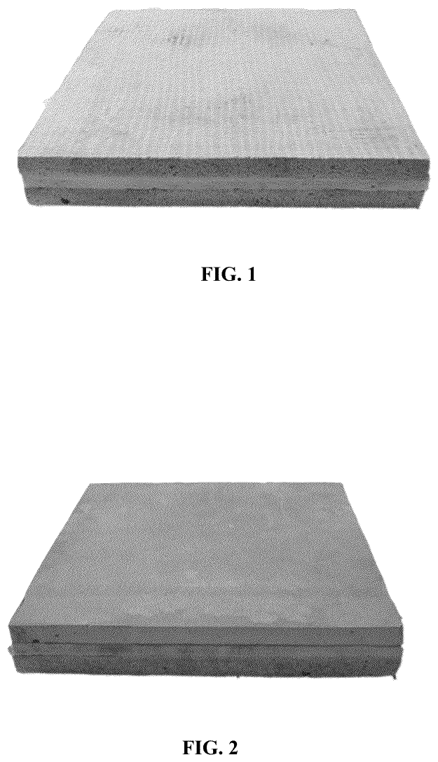

FIG. 1 is a schematic diagram of an active and passive integrated fireproof heat-insulating board of Example 1.

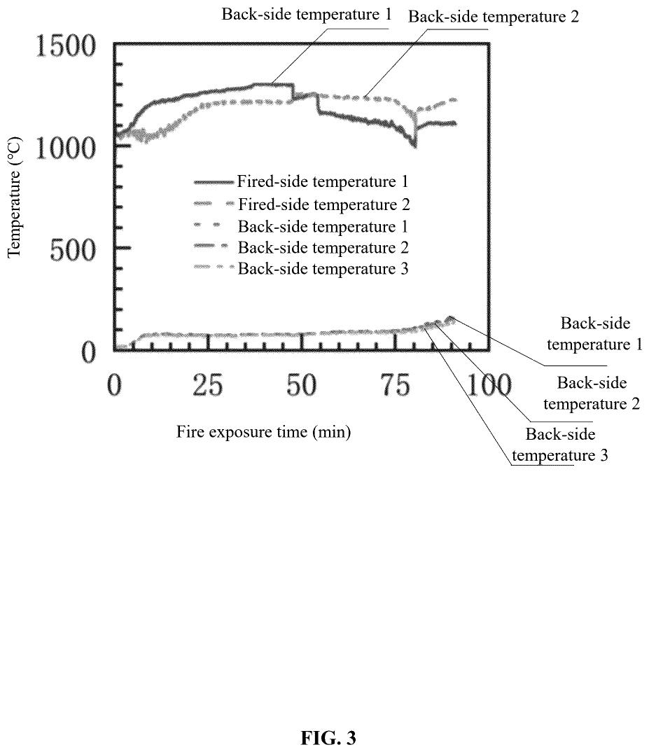

FIG. 3 is a schematic diagram of temperature curves of a fire-exposed surface and temperature curves of an unexposed surface of an active and passive integrated fireproof heat-insulating board according to some embodiments in the present disclosure. In FIG. 3, the horizontal axis represents a fire exposure time of the fire-exposed surface or the unexposed surface of the active and passive integrated fireproof heat-insulating board, while the vertical axis represents a temperature of the fire-exposed surface or the unexposed surface of the active and passive integrated fireproof heat-insulating board corresponding to each fire exposure time point.

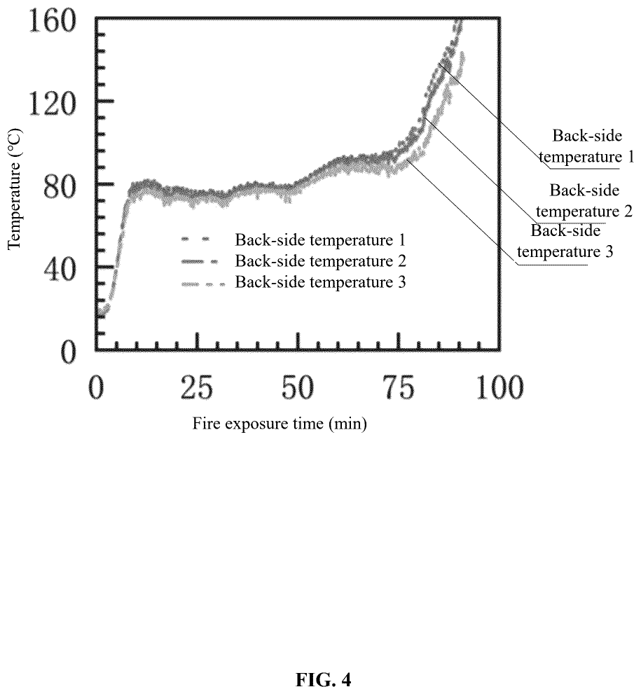

FIG. 4 is a schematic diagram of temperature curves of an unexposed surface of an active and passive integrated fireproof heat-insulating board according to some embodiments in the present disclosure. In FIG. 4, the horizontal axis represents a fire exposure time of the unexposed surface of the active and passive integrated fireproof heat-insulating board, while the vertical axis represents a temperature of the unexposed surface of the active and passive integrated fireproof heat-insulating board corresponding to each fire exposure time point. FIG. 4 is an enlarged view of three back-side temperature curves shown in FIG. 3.

FIG. 5 a schematic diagram of a state of the active and passive integrated fireproof heat-insulating board of Example 1 during a combustion test.

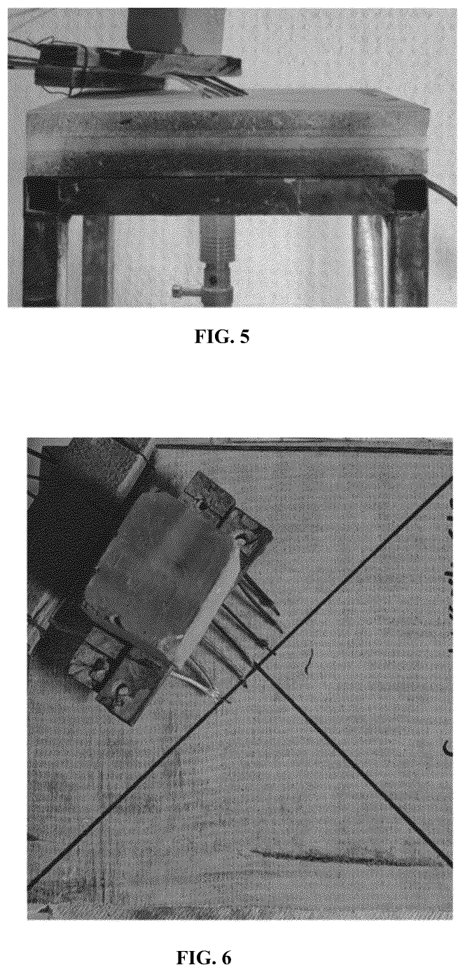

FIG. 6 is a schematic diagram of a back view of the active and passive integrated fireproof heat-insulating board of Example 1 after the combustion test.

As shown in FIG. 1, the active and passive integrated fireproof heat-insulating board in Example 1 includes a passive fireproof layer and two commercially available glass magnesium fireproof boards, and the two commercially available glass magnesium fireproof boards are located on both sides of the passive fireproof layer to form a sandwich structure. The passive fireproof layer includes an aerogel and an aluminum silicate fiber felt, and the aerogel is formed by curing an aerogel stock solution filled in gaps of the aluminum silicate fiber felt and coating an exterior of the aluminum silicate fiber felt. The aluminum silicate fiber felt has a thickness of 15 mm. In parts by mass, the aerogel stock solution includes 1000 parts of silica sol, 15 parts of aluminum dihydrogen phosphate, 100 parts of lithium silicate, 10 parts of quicklime, 10 parts of titanium dioxide, 10 parts of calcium stearate, 50 parts of polydimethylsiloxane (hydrophobic modifier), 5 parts of acetic acid (pH regulator), and 3000 parts of water.

The preparation method of the fireproof heat-insulating board is as follows:

S1: preparing a raw material and a solvent in proportion; adding 100 parts of lithium silicate, 10 parts of quicklime, and 10 parts of titanium dioxide into ½ of the water, stirring at a stirring speed of 500 r/min, to obtain a mixed solution 1 after stirring; and adding 1000 parts of silica sol and 15 parts of aluminum dihydrogen phosphate into the remaining ½ of the water, stirring at a stirring speed of 500 r/min to obtain a mixed solution 2 after stirring.

S2: mixing the mixed solution 1 and the mixed solution 2 obtained in the step S1 and stirring at a stirring speed of 1500 r/min, adding acetic acid to adjust the pH to 6 during stirring, and obtaining a mixed solution 3 after stirring.

S3: adding 10 parts of calcium stearate and 50 parts of polydimethylsiloxane into the mixed solution 3 obtained in the step S2, stirring at a low stirring speed of 500 r/min to obtain an adhesive aerogel stock solution.

S4: drying the aluminum silicate fiber felt at a drying temperature of 100° C. for 18 h, impregnating the dried aluminum silicate fiber felt into the adhesive aerogel stock solution obtained in the step S3 for 20 min to obtain an aluminum silicate fiber felt impregnated with the aerogel stock solution.

S5: laying the aluminum silicate fiber felt impregnated with the aerogel stock solution obtained in the step S4 on one glass magnesium fireproof board, and taking the other glass magnesium fireproof board laying on the other side of the aluminum silicate fiber felt to obtain an unshaped fireproof heat-insulating plate.

S6: wrapping a layer of PVA plastic film around the unshaped fireproof heat-insulating board obtained in the step S5, then applying 2 MPa to the unshaped fireproof heat-insulating board and curing the gel in a curing box at 45° C. for 30 min, after the gel is shaped, it is transferring to a microwave frequency band of 1000 MHz to 2500 MHz and aging at 60° C. for 30 min, so that the active and passive integrated fireproof heat-insulating board is prepared.

The active and passive integrated fireproof heat-insulating board in Example 1 is subjected to a 1200° C. combustion test (referring to FIG. 5 for the test state), the fired-side temperature and the back-side temperature of the active and passive integrated fireproof heat-insulating board are recorded. The temperature curves of the fired-side temperature 1 are shown in FIG. 3, the temperature curves of the back-side temperature 1 are shown in FIG. 3 and FIG. 4 (the three back-side temperature curves in FIG. 3 basically overlap, and FIG. 4 is an enlarged view of the three back-side temperature curves shown in FIG. 3). It can be seen from FIG. 3 that when the fired-side temperature 1 is in a range of 1000° C. to 1300° C., the back-side temperature 1 never exceeds 200° C. within 0 min to 90 min during the combustion test, especially the back-side temperature 1 is maintained at a low temperature of 70° C. to 90° C. during the combustion test time of 0 min to 75 min. After the combustion test is finished, the heat-insulating unexposed surface of Example 1 is observed, as shown in FIG. 6, the unexposed surface still keeps the original color of the heat-insulating board, and no black paste phenomenon occurs. The equivalent density of the active and passive integrated fireproof heat-insulating board in Example 1 is only 0.7 g/cm³, indicating that the active and passive integrated fireproof heat-insulating board in Example 1 has a very low equivalent density, light weight, and excellent flame retardant and heat-insulating effect.

### Example 2

The present example provides another active and passive integrated fireproof heat-insulating board, which differs from Example 1 in that: the fireproof heat-insulating board includes a passive fireproof layer and a gypsum fireproof board (total of 2 layers), the passive fireproof layer includes an aerogel and a glass fiber felt, and the aerogel is formed by curing an aerogel stock solution filled in gaps of the glass fiber felt and coating an exterior of the glass fiber felt. The aerogel stock solution includes, in parts by mass, 3000 parts of silica sol, 100 parts of lithium silicate, 15 parts of zinc phosphate, 12 parts of quicklime, 10 parts of titanium dioxide, 10 parts of calcium stearate, 45 parts of trimethylchlorosilane (hydrophobic modifier), 5 parts of hydrochloric acid (pH regulator, adjust the pH of the aerogel stock solution to 6), and 4000 parts of water.

The preparation method of the active and passive integrated fireproof heat-insulating board is shown in Example 1, and the glass fiber felt is impregnated in the aerogel stock solution for 30 min. The curing conditions include: applying 5 MPa to an unshaped fireproof heat-insulating board and curing the gel in a curing box at 50° C. for 30 min, transferring to a microwave frequency band of 1000 MHz to 2500 MHz and aging at 50° C. for 20 min. After testing, the active and passive integrated fireproof heat-insulating board in Example 2 with a thickness of 24 mm has a fire resistance limit of over 70 min and a volume water absorption rate in humid air within 24 h less than 5%.

Example 3

The present example provides another active and passive integrated fireproof heat-insulating board, and differs from Example 1 in that: the fireproof thermal heat-insulating board includes a passive fireproof layer and two gypsum fireproof boards, and the passive fireproof layer is sandwiched between the two gypsum fireproof boards. The passive fireproof layer includes an aerogel and a mullite fiber felt, and the aerogel is formed by curing an aerogel stock solution filled in gaps of the mullite fiber felt and coating an exterior of the mullite fiber felt. The aerogel stock solution includes, in parts by mass, 2000 parts of silica sol, 150 parts of sodium silicate, 30 parts of aluminum dihydrogen phosphate, 20 parts of quicklime, 10 parts of titanium dioxide, 10 parts of calcium stearate, 20 parts of trimethylchlorosilane (hydrophobic modifier), 30 parts of dimethyldimethoxysilane (hydrophobic modifier), 10 parts of acetic acid, and 3600parts of water. The preparation method of the active and passive integrated fireproof heat-insulating board is shown in Example 1.

The active and passive integrated fireproof heat-insulating board in Example 3 is subjected to a 1200° C. combustion test (referring to FIG. 5 for a test state), a fired-side temperature 2 and a back-side temperature 2 of the active and passive integrated fireproof heat-insulating board are recorded, the temperature curves of the fired-side temperature 2 are shown in FIG. 3, the temperature curves of the back-side temperature 2 are shown in FIG. 3 and FIG. 4. It can be seen from the drawings that when the fired-side temperature 2 is in a range of 1000° C. to 1300° C., the back-side temperature 2 never exceeds 200° C. within 0 min to 90 min during the combustion test, especially the back-side temperature 2 is maintained at a low temperature of 70° C. to 90° C. during the combustion test time of 0 min to 75 min. It can be seen therefrom that the active and passive integrated fireproof heat-insulating board in Example 3 has an excellent flame retardant and heat-insulating effect.

Example 4

FIG. 2 is a schematic diagram of an active and passive integrated fireproof heat-insulating board of Example 4.

The present example provides an active and passive integrated fireproof heat-insulating board, and as shown in FIG. 2, the present example differs from Example 1 in that: the fireproof heat-insulating board includes a passive fireproof layer, a gypsum fireproof board, and a glass magnesium fireproof board, and the passive fireproof layer is sandwiched between the gypsum fireproof board and the glass magnesium fireproof board to form a sandwich structure. The passive fireproof layer includes an aerogel and an aluminum silicate fiber felt, and the aerogel is formed by curing an aerogel stock solution filled in gaps of the aluminum silicate fiber felt and coating an exterior of the aluminum silicate fiber felt. The composition of the aerogel stock solution is to add 10 parts of a phase change microcapsule material on the basis of Example 1, and the preparation method of the fireproof heat-insulating board is shown in Example 1. The phase change microcapsule material is added into the aerogel stock solution in the step S3.

A shell layer of the phase change microcapsule material is melamine-formaldehyde resin (60% by mass), a phase change core material is sodium sulfate dodecahydrate (40% by mass), and a particle size of the phase change microcapsule material is in a range of 100 to 300 μm, the preparation process of the phase change microcapsule material may refer to the prior art or the following process: (1) dissolving sodium sulfate dodecahydrate in a proper amount of warm water at a temperature of 50° C. to 60° C. to form a uniform solution to obtain a sodium sulfate aqueous solution; (2) adding acetone into a container and adding 2% of a hydrophobic surfactant; and (3) stirring at a stirring speed of 15 r/min to 20 r/min, while stirring, slowly dropwise adding the sodium sulfate aqueous solution into the acetone to form a stable W/O emulsion; (4) mixing melamine and formaldehyde in a molar ratio of 1:3, and adjusting the pH to a range of 8 to 9 with a pH regulator to promote the generation of a prepolymer to obtain a melamine-formaldehyde prepolymer solution; (5) stirring at a stirring speed of 15 r/min to 20 r/min, and gradually dropwise adding the melamine-formaldehyde prepolymer solution into the W/O emulsion while stirring; and heating to 85° C. to promote the occurrence of a crosslinking reaction, reacting for 3 h, filtering, and drying the precipitate to obtain the phase change microcapsule material.

The active and passive integrated fireproof heat-insulating board in Example 4 is subjected to a 1200° C. combustion test (referring to FIG. 5 for a test state), the temperature curved of the fired-side temperature 1 are shown in FIG. 3 (carrying out synchronous tests with the heat-insulating board of Example 1), the temperature curves of the back-side temperature 3are shown in FIG. 3 and FIG. 4. It can be seen from the drawings that when the fired-side temperature is in a range of 1000° C. to 1300° C., the back-side temperature 3 never exceeds 200° C. within 0 min to 90 min during the combustion test, especially the back-side temperature 3 is maintained at a low temperature of 70° C. to 90° C. during the combustion test time of 0 min to 75 min. The back-side temperature 3 at each time point during the fire exposure period is always lower than the back-side temperature 1 and the back-side temperature 2, which indicates that the active and passive integrated fireproof heat-insulating board in Example 4 has better thermal insulation capability.

### Example 5

This example provides an active and passive integrated fireproof heat-insulating board, and differs from Example 1 in that: the fireproof thermal heat-insulating board includes two passive fireproof layers and three cement fiberboards. It can be learned from the temperature curves of the fired-side temperature and the temperature curves of the back-side temperature of the fireproof heat-insulating board that the fireproof heat-insulating board in Example 5 can resist the back-side temperature of 1200° C. for more than 110 min, and as the count of layers increases, the capacity to insulate heat also increases, ensuring that the back-side temperature remains stable for a long time and providing excellent and stable fire resistance.

Finally, it should be noted that the above examples are only used to illustrate the technical solutions of the present disclosure and are not limited thereto. Although the present disclosure is described in detail with reference to the foregoing examples, a person of ordinary skill in the art should understand that the technical solutions described in the foregoing examples can still be modified, or some or all of the technical features can be equivalently replaced; and these modifications or replacements do not make the essence of the corresponding technical solutions separate from the scope of the technical solutions of the examples of the present disclosure.

1. An active and passive integrated fireproof heat-insulating board, comprising: n passive fireproof layers and n or n+1 active fireproof layers, n being a natural number; wherein:
the n passive fireproof layers and the n or n+1 active fireproof layers are overlapped by an alternate overlapping manner or a sandwich filling overlapping manner, and combined into an integrated structure by pressurized gel shaping and curing;
each active fireproof layer is an inorganic fireproof board that actively consumes energy when decomposed by heat, and the inorganic fireproof board includes at least one of a gypsum fireproof plate, a glass magnesium fireproof plate, a cement fiber plate, and a silicate fiber plate; and
each passive fireproof layer includes an aerogel and an inorganic fiber felt serving as a porous skeleton material, the aerogel is filled in pores of the porous skeleton material and coats an exterior of the porous skeleton material; the aerogel is obtained by curing and drying an aerogel stock solution having adhesiveness, and the aerogel stock solution includes, in parts by mass, 1000 to 4000 parts of silica sol, 50 to 150 parts of soluble silicate, 10 to 50 parts of a phosphate adhesive, 5 to 20 parts of quicklime, 5 to 50 parts of titanium dioxide, 10 to 50 parts of calcium stearate, 5 to 50 parts of a hydrophobic modifier, 5 to 50 parts of an acid-base regulator, and 1000 to 4000 parts of a solvent.

2-3. (canceled)

4. The active and passive integrated fireproof heat-insulating board according to claim 1, wherein the inorganic fiber felt is a fiber felt composed of one or a mixture of two or more of a mullite fiber felt, an aluminum silicate fiber felt, a glass fiber felt, and an alumina fiber felt.

5. The active and passive integrated fireproof heat-insulating board according to claim 1, wherein in the each passive fireproof layer, a mass ratio of the inorganic fiber felt is in a range of 70% to 95%, with the remainder being the aerogel.

6. The active and passive integrated fireproof heat-insulating board according to claim 1, wherein the phosphate adhesive is at least one of aluminum dihydrogen phosphate, magnesium phosphate, and zinc phosphate, and the soluble silicate is at least one of lithium silicate, sodium silicate, and potassium silicate.

7. The active and passive integrated fireproof heat-insulating board according to claim 1, wherein the aerogel stock solution further includes, in parts by mass, 10 to 30 parts of a phase change microcapsule material, a shell layer of the phase change microcapsule material is one of silicon dioxide, melamine-formaldehyde resin, polyurea-polyurethane, and polyamide, and a phase change core material of the phase change microcapsule material is at least one of paraffin, alkane, fatty acid and esters thereof, sodium sulfate dodecahydrate, calcium chloride hexahydrate, polyethylene glycol, and neopentyl glycol.

8. The active and passive integrated fireproof heat-insulating board according to claim 7, wherein the shell layer of the phase change microcapsule material is the polyurea-polyurethane or the polyamide, and flame retardant element monomers or additives are introduced into the polyurea-polyurethane or the polyamide.

9. A preparation method of an active and passive integrated fireproof heat-insulating board, comprising:
S1: preparing all raw materials of the aerogel stock solution according to the active and passive integrated fireproof heat-insulating board in claim 1, dividing the solvent into a first portion and a second portion, adding the soluble silicate, the quicklime, and the titanium dioxide into the first portion of the solvent, and stirring to obtain a mixed solution 1; adding the silica sol and the phosphate adhesive into the second portion of the solvent, and stirring to obtain a mixed solution 2;
S2: mixing the mixed solution 1 and the mixed solution 2 obtained in the step S1 and stirring to obtain a mixture, and adding the acid-base regulator to adjust pH of the mixture composed of the mixed solution 1 and the mixed solution 2 to a range of 6 to 7 during the stirring to obtain a mixed solution 3;
S3: adding the calcium stearate and the hydrophobic modifier to the mixed solution 3 obtained in the step S2 and stirring to obtain the aerogel stock solution;
S4: impregnating the inorganic fiber felt with the aerogel stock solution obtained in the step S3 until the inorganic fiber felt is fully impregnated to obtain an inorganic fiber felt impregnated with the aerogel stock solution;
S5: overlapping the inorganic fiber felt impregnated with the aerogel stock solution obtained in the step S4 with the n or n+1 active fireproof layers to obtain an unshaped fireproof heat-insulating board; and
S6: subjecting the unshaped fireproof heat-insulating board obtained in the step S5 first to pressurized gel shaping and curing, and then subjecting to microwave drying and aging treatment to obtain the active and passive integrated fireproof heat-insulating board.

10. The preparation method according to claim 9, wherein during mixing and stirring the mixed solution 1 and the mixed solution 2, the acid-base regulator is added to adjust the pH of the mixture composed of the mixed solution 1 and the mixed solution 2 to 6.

11. The preparation method according to claim 9, wherein in the step S4, before the inorganic fiber felt is impregnated, the inorganic fiber felt is dried to remove moisture from the inorganic fiber felt to absorb the aerogel stock solution prepared in the step S3.

12. The preparation method according to claim 11, wherein the inorganic fiber felt is dried at a temperature of 40° C. to 120° C. and a drying time of 12 h to 24 h.

13. The preparation method according to claim 9, wherein in the step S6, conditions for the pressurized gel shaping and curing include: maintaining the unshaped fireproof heat-insulating board obtained in the step S5at a pressure of 2 MPa to 5 MPa and a temperature of 30° C. to 50° C. for curing for 15 min to 1 h.

14. The preparation method according to claim 9, wherein in the step S6, conditions for the microwave drying and aging treatment include: subjecting the unshaped fireproof heat-insulating board that has finished the pressurized gel shaping and curing to drying and aging in a microwave frequency band of 1000 MHz to 2500 MHz and at a temperature of 50° C. to 100° C. for 1 min to 30 min.

15. The preparation method according to claim 9, wherein, in parts by mass, 50 to 150 parts of the soluble silicate, 5 to 20 parts of the quicklime, and 5 to 50 parts of the titanium dioxide are added to the first portion of the solvent; 1000 to 4000 parts of the silica sol and 10 to 50 parts of the phosphate adhesive are added to the second portion of the solvent; and 10 to 50 parts of the calcium stearate and 5 to 50 parts of the hydrophobic modifier are added to the mixed solution 3.

16. The preparation method according to claim 9, wherein the adding the calcium stearate and the hydrophobic modifier to the mixed solution 3 obtained in the step S2 and stirring to obtain the aerogel stock solution includes:
adding the calcium stearate, the hydrophobic modifier, and a phase change microcapsule material to the mixed solution 3 obtained in the step S2 and stirring to obtain the aerogel stock solution.
